(19) United States
(12) Patent Application Publication
(10) Pub. No.: US 2014/0304020 A1
(43) Pub. Date: Oct. 9, 2014

(54) LABOR OPTIMIZATION PLATFORM

(71) Applicant: Casper & Friends, Inc., Odessa, FL (US)

(72) Inventor: Gary Casper, Odessa, FL (US)

(73) Assignee: CASPER & FRIENDS, INC., Odessa, FL (US)

(21) Appl. No.: 14/220,778

(22) Filed: Mar. 20, 2014

Related U.S. Application Data
(60) Provisional application No. 61/853,506, filed on Apr. 8, 2013.

(51) Int. Cl. G06Q 10/06

(52) U.S. Cl. CPC G06Q 10/063118
USPC 705/7.17

(57) ABSTRACT

The present invention provides a labor optimization system comprising listing one or more available employee work schedules into a web based system. The listing of available employee work schedules is created by one or more employers from one or more companies. A rating system created by the employer is allocated for one or more job functions to each available employee work schedule. One or more of the job function for the available employee work schedules are bided on by one or more employees via the web based system. The bidding is based on an employee wage wherein the employee wage decreases with each bid. A rating score is assigned for each bidding employee wherein the rating score is based on one or more factors. The rating score is assigned based on the job function for the available employee work schedule. A winning employee for the available employee work schedule is determined based on the assigned rating score for the job function for the bidding employee and based on the bided employee wage. The available employee work schedule is awarded to the winning employee via the web based system.

### CROSS REFERENCES TO RELATED APPLICATIONS

This application claims priority from and is related to commonly owned U.S. Provisional Patent Application Ser. No. 61/853,506 filed Apr. 8, 2013, entitled: Scheduling System, this Provisional Patent Application incorporated by reference herein.

### FIELD OF THE INVENTION

The present invention relates to a system and method for optimizing labor resources. The invention allows employers to have efficient scheduling of employees at an unbiased wage and the invention allows employees to know and receive a true value for their labor.

### BACKGROUND OF THE INVENTION

History has an unlimited number of examples of the conflicts between labor and management. There has always been an adversarial relationship, between the two. Some would argue that it is precisely this relationship that creates an optimum equilibrium. However, this relationship is not in equilibrium and is completely inefficient. The power of labor ebbs and flows, from an almost complete monopoly to none at all. Cities go bankrupt as do companies due to the current inefficient system for the employment and scheduling of employees. Moreover, many companies leave the United States due to the current inefficient system for the employment and scheduling of employees.

Companies hire and fire employees at great expense. Unproductive employees remain, sometimes at positions that they dislike or with duties that they are unable to perform. Government agencies monitor the activities of the human resource (HR) department. HR departments have become behemoths, an expensive and unproductive cost of doing business.

Employees have to settle for jobs, and hours they do not like for a stable paycheck. Many times the employee becomes stuck at a dead end job with no chance of advancement. Other times, employees are passed over for promotions with no idea why. Many times an excellent employee receives the same salary (or less) than the unproductive employee. For management, an unhappy employee will become an unproductive employee.

Therefore, what is needed is a labor optimization system which allows employers to have efficient scheduling of employees at an unbiased wage and allows employees to know and receive a true value for their labor.

Nothing in the prior art provides the benefits attendant with the present invention.

Therefore, it is an object of the present invention to provide an improvement which overcomes the inadequacies of the prior art systems and which is a significant contribution to the advancement of labor optimization.

Another object of the present invention is to provide a labor optimization system comprising: listing one or more available employee work schedules into a web based system, said listing of available employee work schedules being created by one or more employers from one or more companies; allocating a rating system for one or more job functions to each available employee work schedule, said rating system being created by the employer; bidding on one or more of the job functions for the available employee work schedules via the web based system, said bidding by one or more employees, said bidding being based on an employee wage, said employee wage decreasing with each bid; assigning a rating score for each bidding employee, said rating score being based on one or more factors, said rating score being assigned based on the job function for the available employee work schedule; determining a winning employee for the available employee work schedule based on the assigned rating score for the job function for the bidding employee and based on the bided employee wage; and awarding the available employee work schedule to the winning employee via the web based system.

Yet another object of the present invention is to provide a cashier employment scheduling system comprising: listing one or more available cashier work schedules into a web based system, said listing of available cashier work schedules being created by one or more employers from one or more stores; allocating a rating system to each available cashier work schedule, said rating system being created by the employer; bidding on one or more of the available cashier work schedules via the web based system, said bidding by one or more cashiers, said bidding being based on a cahier wage, said cashier wage decreasing with each bid; assigning a rating score for each bidding cashier, said rating score being based on one or more factors; determining a winning cashier for the available cashier work schedule based on the assigned rating score for the cashier and based on the bided cashier wage; and awarding the available cashier work schedule to the winning cashier via the web based system.

The foregoing has outlined some of the pertinent objects of the present invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

The present invention creates a true “free market” system for the pricing of labor. The employees will bid in an auction setting for the hours that they desire to work. An adjustable set of variables for the employers have been contemplated so that the employers may create their own algorithm, according to the importance that their own company places on each variable. By adding the variables into a formula, a company may rate the quality/comparable value of each employee. The employees, by seeing their rating, should have an incentive to increase said rating. Therefore, a true and direct feedback incentive system for the employment relationship has been created.

Another feature of the present invention is to provide a labor optimization system comprising one or more available employee work schedules that are listed by one or more employers from one or more companies into a web based system. A rating system for one or more job functions is allocated to each available employee work schedule. The rating system is created by the respective employer. The rating system can comprise one or more objective standards for each job function of the available employee work schedule and a set of variables for each job function of the available employee work schedule wherein the set of variables can be determined by the respective employer of the available employee work schedule. The variables can be added or deleted by the respective employer for the available employee work schedule. The respective employer can determine a weight for each variable for each job function for the available employee work schedule. One or more of the job functions for the available employee work schedules is bided on by one or more employees via the web based system. The bidding is based on an employee wage wherein the employee wage decreases with each bid. The bided wage can be automatically accepted based on set point that is triggered when the bided wage reaches a threshold wage as set by the respective employer for the job function for the available employee work schedule. A rating score for each bidding employee is assigned based on one or more factors. The factors can include a wage earning for the employee, a customer service rating for the employee, an accuracy rating for the employee, a speed rating for the employee, a health rating for the employee, a language rating for the employee, and a merchandising rating for the employee. The rating score is assigned based on the job function for the available employee work schedule. A winning employee for the available employee work schedule is determined based on the assigned rating score for the job function for the bidding employee and is based on the bided employee wage. The available employee work schedule is awarded to the winning employee via the web based system.

Yet another feature of the present invention is to provide a cashier employment scheduling system comprising one or more available cashier work schedules that are listed by one or more employers from one or more stores into a web based system. A rating system is allocated to each available cashier work schedule. The rating system is created by the respective employer. The rating system can comprise one or more objective standards for the available cashier work schedule and a set of variables for the available cashier work schedule wherein the set of variables can be determined by the respective employer of the available cashier work schedule. The variables can be added or deleted by the respective employer for the available cashier work schedule. The respective employer can determine a weight for each variable for the available cashier work schedule. One or more of the available cashier work schedules is bided on by one or more cashiers via the web based system. The bidding is based on a cahier wage wherein the cashier wage decreases with each bid. The bided wage can be automatically accepted based on set point that is triggered when the bided wage reaches a threshold wage as set by the respective employer for the available cashier work schedule. A rating score is assigned for each bidding cashier. The rating score is based on one or more factors. The factors can include a wage earning for the cashier, a customer service rating for the cashier, an accuracy rating for the cashier, a speed rating for the cashier, a health rating for the cashier, a language rating for the cashier, and a merchandising rating for the cashier. A winning cashier is determined for the available cashier work schedule based on the assigned rating score for the cashier and based on the bided cashier wage. The available cashier work schedule is awarded to the winning cashier via the web based system.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 is a block diagram depicting a system for labor optimization according to an embodiment of the invention; and

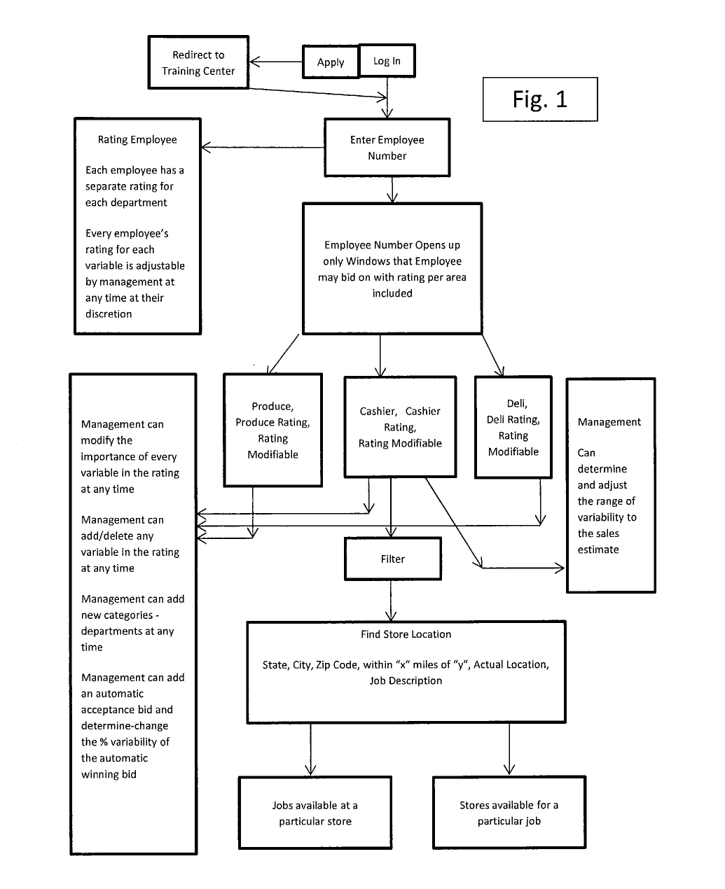

FIG. 2 is a continuation of the block diagram of FIG. 1 depicting a system for labor optimization according to an embodiment of the invention.

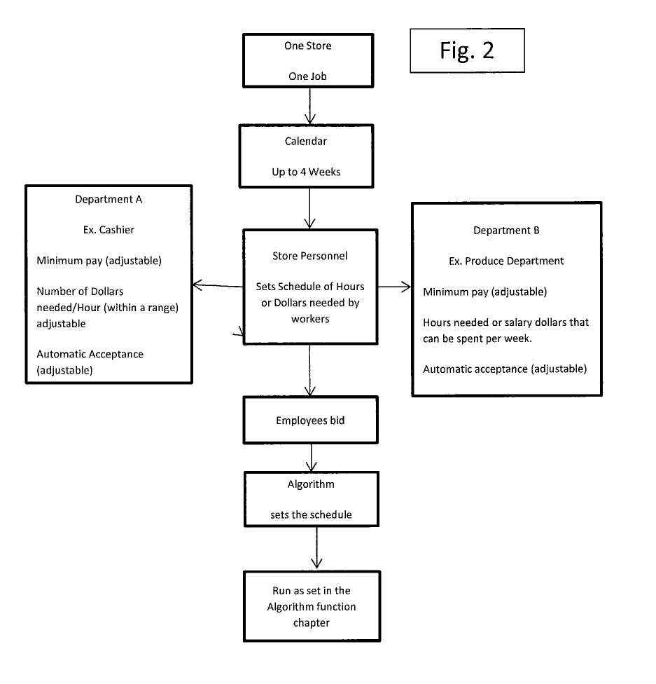

Similar reference characters refer to similar parts throughout the several views of the drawings.

### DETAILED DESCRIPTION OF THE INVENTION

The following is a description of one embodiment of the labor optimization system of the present invention using a cashier at a grocery store as the employee. In this embodiment, the variables in the algorithm are: how many dollars/hour the cashier can ring up; the cashier's ability to handle customer service functions; the number of sick/late days for the cashier; the accuracy of the cashier's drawer; and the cashier's bilingual ability. For the minimally acceptable cashier, the algorithm is preset at $1000/hour=1, 1 sick day per quarter taken=0.1, accuracy of cash drawer ($5 per week)=0.1, tardiness=0.1, bilingual (two relevant languages spoken fluently)=+0.1. Therefore, the algorithm for a minimally acceptable cashier would be 1+0.1+0.1+0.1=1.3. The bilingual cashier would automatically have a score of up to 1.4. If a cashier has a score in any variable that falls below the minimal acceptable level, the cashier would be subject to probation or retraining. The store should have a written policy for such events. Most of these variables are objective and not subject to subjective scoring by a supervisor. The only subjective scoring could arise in the customer service variable. Thus, an outside, unbiased service, should rate the customer service variable, e.g., “secret shopper” for the cashier.

The employers should not only have the ability to adjust the variable, but they should also be able to add, delete, or change the variables. For example, a clothing store could delete the accuracy of cash drawer variable, change the dollars/hour variable, and maybe add a merchandising variable. An automatic acceptance function for a bid can be included in the system. For example, the default winning bid should be 10% below the employer's current employee cost structure. This default setting will also be adjustable.

The employers should have an efficient scheduling and an unbiased wage pricing and promotion system. The employers determine the algorithm and fill in the variables, and the system will set the schedule. The employees will have a system where they will know and receive the true value of their labor. Also, the employees should be able to better control their working schedule. For example, if the cashier has a college class on Tuesdays and Thursdays from 2-4 then in order to work a 40-hour week, this cashier would have to work every weekend or nights. Using the present invention, the cashier could set their own schedule. The cashier would have the opportunity to bid a higher wage asking price on the weekends, bid a four-hour day on Tuesday and Thursday, or even bid on an eight-hour block at one company and a four-hour block at another company on Mondays. The cashier will control their own labor rates by each four-hour block, their schedule, and their employer, all on a daily basis. Note, the employers may also, at their discretion, modify the four-hour block to greater time blocks.

The system of the present invention cannot identify the employees, therefore all “protected classes” should not only be protected, but they should also have an equal chance of filling any available employment slot.

Using the system of the present invention should outmode the old model of training and keeping an employee restricted to one store. The present invention creates a truly “free movement of labor” model. Unions may now inherit the duty of training an employee to work at multiple companies and with multiple skills. Companies may continue to set their own performance level and rate each employee on their own system. The present invention allows the employer to have: a more efficient scheduling system that should lower labor costs; a defendable system for hiring and promoting employees; an incentive-based system for employees to improve their performance; lower HR costs; the ability for employees to choose their schedule based upon their own needs; and possible lower health insurance costs. Combined, the companies should defray much of their training costs and create a larger pool of trained workers. The unions should receive the training fees, which should be much larger than their current dues structure. The unions may install a floating healthcare system for all the employees, where the employers should pay the costs to the union on a per hour worked basis. The unions should now receive fees for managing the healthcare insurance program, and the employees should now gravitate toward this system.

This is a web-based system where the employers should exhibit their schedules, and the authorized employees should view the schedules and bid on the hours that they desire to work. The companies' predetermined algorithm selects the winning bids, and the website notifies each employee of their winning bid. The company may pay their employees through electronic transfers instead of their current method.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A labor optimization system comprising:
listing one or more available employee work schedules into a web based system, said listing of available employee work schedules being created by one or more employers from one or more companies;
allocating a rating system for one or more job functions to each available employee work schedule, said rating system being created by the employer;
bidding on one or more of the job functions for the available employee work schedules via the web based system, said bidding by one or more employees, said bidding being based on an employee wage, said employee wage decreasing with each bid;
assigning a rating score for each bidding employee, said rating score being based on one or more factors, said rating score being assigned based on the job function for the available employee work schedule;
determining a winning employee for the available employee work schedule based on the assigned rating score for the job function for the bidding employee and based on the bided employee wage; and
awarding the available employee work schedule to the winning employee via the web based system.

2. The method according to claim 1 wherein said rating system further comprising:
one or more objective standards for each job function of the available employee work schedule; and
a set of variables for each job function of the available employee work schedule, said set of variables being determined by the employer of the available employee work schedule.

3. The method according to claim 2 further comprising:
adding one or more variables to each job function for the available employee work schedule, said addition being done by the employer; and
deleting one or more variables to each job function for the available employee work schedule, said deletion being done by the employer.

4. The method according to claim 2 further comprising determining a weight for each variable for each job function for the available employee work schedule, said determination being done by the employer.

5. The method according to claim 1 further comprising an automatic acceptance of the bided wage, said automatic acceptance of the bided wage being triggered when the bided wage reaches a threshold wage as set by the employer for the job function for the available employee work schedule.

6. The method according to claim 1 wherein said factors further comprising a wage earning for the employee.

7. The method according to claim 6 wherein said factors further comprising a customer service rating for the employee.

8. The method according to claim 7 wherein said factors further comprising an accuracy rating for the employee.

9. The method according to claim 8 wherein said factors further comprising a speed rating for the employee.

10. The method according to claim 9 wherein said factors further comprising a health rating for the employee.

11. The method according to claim 10 wherein said factors further comprising a language rating for the employee.

12. The method according to claim 11 wherein said factors further comprising a merchandising rating for the employee.

13. A cashier employment scheduling system comprising:
listing one or more available cashier work schedules into a web based system, said listing of available cashier work schedules being created by one or more employers from one or more stores;
allocating a rating system to each available cashier work schedule, said rating system being created by the employer;
bidding on one or more of the available cashier work schedules via the web based system, said bidding by one or more cashiers, said bidding being based on a cahier wage, said cashier wage decreasing with each bid;
assigning a rating score for each bidding cashier, said rating score being based on one or more factors;
determining a winning cashier for the available cashier work schedule based on the assigned rating score for the cashier and based on the bided cashier wage; and
awarding the available cashier work schedule to the winning cashier via the web based system.

14. The method according to claim 13 wherein said rating system further comprising:
one or more objective standards for the available cashier work schedule; and
a set of variables for the available cashier work schedule, said set of variables being determined by the employer of the available cashier work schedule.

15. The method according to claim 14 further comprising:
adding one or more variables to the available cashier work schedule, said addition being done by the employer; and
deleting one or more variables to the available cashier work schedule, said deletion being done by the employer.

16. The method according to claim 14 further comprising determining a weight for each variable for the available cashier work schedule, said determination being done by the employer.

17. The method according to claim 13 further comprising an automatic acceptance of the bided cashier wage, said automatic acceptance of the bided cashier wage being triggered when the bided cashier wage reaches a threshold wage as set by the employer for the available cashier work schedule.

18. The method according to claim 13 wherein said factors further comprising a wage earning for the cashier.

19. The method according to claim 18 wherein said factors further comprising a customer service rating for the cashier.

20. The method according to claim 19 wherein said factors further comprising an accuracy rating for the cashier,

21. The method according to claim 20 wherein said factors further comprising a speed rating for the cashier.

22. The method according to claim 21 wherein said factors further comprising a health rating for the cashier.

23. The method according to claim 22 wherein said factors further comprising a language rating for the cashier.

24. The method according to claim 23 wherein said factors further comprising a merchandising rating for the cashier.
